(19) United States
(12) Patent Application Publication
(10) Pub. No.: US 2023/0062057 A1
(43) Pub. Date: Mar. 2, 2023

(54) PROBIOTIC EGG WASH

(71) Applicant: GINA SLOAN, STATESVILLE, NC (US)

(72) Inventor: GINA SLOAN, STATESVILLE, NC (US)

(21) Appl. No.: 17/818,182

(22) Filed: Aug. 8, 2022

Related U.S. Application Data
(60) Provisional application No. 63/236,399, filed on Aug. 24, 2021.

(51) Int. Cl. A23K 10/18; A23K 50/75

(52) U.S. Cl. CPC A23K 10/18; A23K 50/75; A23Y 2220/73; A23Y 2220/67; A23Y 2300/49; A23Y 2220/63; A23Y 2220/17

(57) ABSTRACT

A probiotic egg wash for the exterior surface of the eggshell that is ingested by the developing embryo resulting in an established GI tract microbiome that promotes health and outcompetes potential pathogens such as Salmonella is provided herein. In the preferred embodiment, the probiotic wash is composed at least of L. casei, L. rhamnosus, L. planitarum, L. paracasei, and/or B. lactis at a concentration of between 10² to 10⁹ CFU per egg.

This non-provisional patent application claims all benefits under 35 U.S.C. § 119(e) of pending U.S. provisional patent application Ser. No. 63/236,399 filed 24 Aug. 2021, entitled “Probiotic Egg Wash”, in the United States Patent and Trademark Office, which is incorporated by reference in its entirety herein.

### FIELD OF THE INVENTION

The disclosure herein pertains probiotic treatments generally, and particularly pertains to a probiotic wash applied to the exterior surface of an eggshell that is ingested by the developing embryo resulting in an established GI tract microbiome that promotes health and outcompetes potential pathogens.

### DESCRIPTION OF THE PRIOR ART AND OBJECTIVES OF THE INVENTION

The U.S. Center for Disease Control (CDC) estimates that food-borne Salmonella causes 1.3 million infections every year in the United States (see: Prevention CDC and Salmonella at https://www.cdc.gov/salmonella/index.html). While there have been numerous attempts over the last decade to reduce the incidence of Salmonella, it continues to be a pathogen of concern, with only a 5% decrease in infection rates since 2016 (see: Tack D M, Marder E P, Griffin P M, et al. Preliminary incidence and trends of infections with pathogens transmitted commonly through food—Foodborne Diseases Active Surveillance Network, 10 U.S. sites, 2015-2018. Am J Transplant. 2019; 19(6):1859-1863. doi:10.1111/ajt.15412). The Interagency Food Safety Analytics Collaboration attributes 14% of foodborne Salmonella to result from either chicken or turkey. Over the last decade multiple interventions to reduce Salmonella transmission via the poultry industry have been tried with little success. These interventions include but are not limited to egg sanitization at hatcheries, sanitization of the poultry housing environment, probiotics post-hatching, prebiotics post-hatching, antibiotic treatment, and vaccination.

Throughout the poultry industry there are 3 main populations of birds, housed in different locations. Broiler breeders are the parent generation that lay fertilized eggs. The fertilized eggs are then transferred to hatcheries where the fertilized egg is sanitized, incubated, and hatched over a 21-day period. Prior to hatching the eggs may be vaccinated in ovo. After hatching, the chicks are moved to a broiler farm where they are grown to production age for either broiler breeders or food products. Salmonella and alternate pathogens can be tracked throughout the industry, demonstrating vertical transmission of pathogens through the poultry supply chain (see: Crabb H K, Lee Allen J, Maree Devlin J, Matthew Firestone S, Reginald Wilks C, Rudkin Gilkerson J. Salmonella spp. transmission in a vertically integrated poultry operation: Clustering and diversity analysis using phenotyping (serotyping, phage typing) and genotyping (MLVA). PLoS One. 2018; 13(7):1-19. doi:10.1371/journal.pone.0201031). Controlling the risk of Salmonella transmission carries throughout the supply chain from egg to mature hen.

The eggshell is the boundary between the environment and the developing chick. It is the first layer of defense against encroaching bacterial contamination of the developing embryo. Bacteria that are deposited on the exterior of the egg can traverse the shell. This is most common with gram negative motile bacteria such as Pseudomonas and Salmonella (see: K De Reu, L Grijspeerdt, W Messens, M Heyndrickx, J Debevere L H. Eggshell factors influencing eggshell penetration and whole egg contamination by different bacteria, including Salmonella enteritidis. Int J Food Microbiology. 2006; 112(3):253-260; see also: Gantois I, Ducatelle R, Pasmans F, et al. Mechanisms of egg contamination by Salmonella Enteritidis: Review article. FEMS Microbiol Rev. 2009; 33(4):718-738. doi:10.1111/j.1574-6976.2008.00161.x). The ability of pathogens to enter the albumin and yolk indicates a potential entry point of pathogens into the poultry life cycle. The eggshell may be contaminated during passage through the oviduct of the breeder hen or through the environment in the hatchery. Once contaminated it can take as little as 24 hours for the bacteria to migrate from the exterior of the eggshell into the yolk. Bacterial contamination of the interior portion of the egg can result in a chick that is colonized in ovo with the invading bacterial species. The origin of the eggshell microbiome may arise from the hen during egg development and laying or from the environment in which the egg is housed. One study concluded that the housing environment has a diminished role in chick gastrointestinal microflora (see: Maki J J, Bobeck E A, Sylte M J, Looft T. Eggshell and environmental bacteria contribute to the intestinal microbiota of growing chickens. J Anim Sci Biotechnol. 2020; 11(1):1-17. doi:10.1186/s40104-020-00459-w).

New studies indicate that the microbiome in the chick embryo originates from the egg white. Over half the microbial diversity from the egg white and subsequently chick embryo originates on the eggshell. One theory is that the microbiome is inherited from the maternal gastrointestinal tract and reproductive track (see: Lee S, La T M, Lee H J, et al. Characterization of microbial communities in the chicken oviduct and the origin of chicken embryo gut microbiota. Sci Rep. 2019; 9(1). doi:10.1038/s41598-019-43280-w). As the egg matures it passes through the reproductive track, coating the eggshell in the maternal reproductive track microbiome. Once the egg exits through the cloaca, it may be coated with fecal material, hence transferring the GI microbiome as well (see: Eggshell and environmental bacteria contribute to the intestinal microbiota of growing chickens supra; see also: Richards-Rios P, Leeming G, Fothergill J, Bernardeau M, Wigleya P. Topical application of adult cecal contents to eggs transplants spore-forming microbiota but not other members of the microbiota to chicks. Appl Environ Microbiol. 2020; 86(5):1-23. doi:10.1128/AEM.02387-19). In fact, the transfer of fecal material is the reason that eggs are typically sanitized in large production areas. The sanitization process inactivates the majority of microbes on the external portion of the eggshell. However, the egg is housed for up to 5 days before being sanitized. During this time bacteria can traverse the eggshell. Once inside the egg, bacteria are not impacted by exterior shell sanitization. This can lead to colonization of the hatching chick with pathogens carried by the hen.

Current practices do not provide a way to influence the microbiome on the eggshell. Instead, existing interventions for controlling pathogens, such as Salmonella, focus on cleaning the egg exterior and environment, promoting GI health in the adult bird, and providing vaccine-induced immunity. Cleaning the egg and environment controls external introduction of bacteria by sanitizing the egg and environment. This has aided in reduction of exposure to pathogens but has not eliminated colonization of the flock. Probiotics, such as Lactobacilli, have been used to replenish good bacteria in the hen. These bacteria have the ability to outcompete pathogens, such as Salmonella, to some degree (see: Abdel-Daim A, Hassouna N, Hafez M, Ashor M S A, Aboulwafa M M. Antagonistic activity of lactobacillus isolates against Salmonella typhi in vitro. Biomed Res Int. 2013; 2013. doi:10.1155/2013/680605). Lactobacillus, along with Bacillus species, have been utilized as direct feed microbes (DFM) of breeders and broilers with the aim of reducing pathogen colonization of the GI track (see: Tellez G, Pixley C, Wolfenden R E, Layton S L, Hargis B M. Probiotics/direct fed microbials for Salmonella control in poultry. Food Res Int. 2012; 45(2):628-633. doi:10.1016/j.foodres.2011.03.047). As DFM agents, the out-competition of existing pathogens is limited. This is because a pathogen, such as Salmonella, has already established colonization in the GI tract of the mature bird, creating a biofilm in the intestinal tract (see: Ledeboer N A, Frye J G, McClelland M, Jones B D. Salmonella enterica Serovar Typhimurium Requires the Lpf, Pef, and Tafi Fimbriae for Biofilm Formation on HEp-2 Tissue Culture Cells and Chicken Intestinal Epithelium. Infect Immun. 2006; 74(6):3156 LP-3169. doi:10.1128/IA1.01428-050). Once a biofilm is established it is up to 100 times more resilient to eradication than its free-swimming, planktonic counterpart. Therefore, the DFM route provides a control measure for the mature bird that allows intermittent relief from pathogen symptoms but not a decolonization of the pathogen. As long as the GI pathogen exists within the mature bird it can be passed onto the eggshell, as described above, and eventually the emerging chick. While all existing strategies to combat potential pathogens are important there has been no focus on utilizing the eggshell of the developing chick. Based on the importance of the eggshell, it is critical for the poultry industry to have an interventional strategy to control the microbiome on the egg itself.

Thus, in view of the problems and disadvantages associated with prior art approaches to eggshell health, the subject matter of the present disclosure was conceived and one of its objectives is to provide a mix of probiotics that is placed directly onto the eggshell. These bacteria will traverse the eggshell to enter the egg white and yolk. Once in the egg white or yolk, the bacteria will be ingested by the developing embryo and create a cascade event resulting in a hatching chick that will have an established GI tract microbiome which promotes health and outcompetes pathogens.

It is another objective of the subject matter of the present disclosure to provide a probiotic egg wash formed from a mixture of probiotics including but not limited to: Aspergillus niger, Aspergillus oryzae, Bacillus amyloliquefaciens, Bacillus coagulens, Bacillus lentus, Bacillus pumilus, Bacteroides amylophilus, Bacteroides capillosus, Bacteroides ruminocola, Bacteroides suis, Bifidobacterium adolescentis, Bifidobacterium animalis, Bifidobacterium infantis, enterococcus cremorus, Enterococcus diacetylactis, Enterococcus faecium, Enterococcus intermedius, Enterococcus lactis, Enterococcus thermophilus, Lactobacillus animalis, Lactobacillus brevis, Lactobacillus bulgaricus, Lactobacillus cellobiosus, Lactobacillus curvatus, Lactobacillus delbruecki, Lactbacillus fermentum, Lactobacillus helveticus, Lactobacillus reuteri, Leuconostic mesenteroides, Pediococcus acidilactici, Pediococcus damnosus, Pediococcus pentosaceus, Propiniobacterium freudenreichii, Propiniobacterium shermanii, Rhodopseudomonas palustris, Saccharomyces cerevisiae, Lactobcillus casei, Lactobacillus rhamnosus, Lactobacillus plantarum, Lactobacillus paracasei, Lactobacillus acidophilus, Lactobacillus lactis, Bacillus subtilis, Bacillus lichenformis, Bifidobacterium bifidum, Bifidobacterium lactis, Bifidobacterium longum, and Bifidobacterium thermophilum. A preferable composition contains at least L. casei, L. rhamnosus, L. planitarum, L. paracasei, or B. lactis.

It is still another objective of the present disclosure to provide a probiotic egg wash in a composition that has a range of colony forming units (CFU) per egg from 10⁵ to 10¹⁵. The preferred wash concentration is 10⁷ to 10¹² CFU per egg. The optimal application rate is 10⁸ to 10¹⁰ CFU per egg. The wash may be provided as a powered concentrate or as a pre-diluted solution, in each case containing active bacteria, and may be applied via spray, dip, or wipe application. Once applied on the egg at the required concentration at least one of the species of bacterial will survive on the eggshell for 3 to 30 days. In some embodiments at least one component of the probiotic composition can survive for up to 21 days on/in the egg. In a preferred embodiment, at least two of the probiotic species can survive on the eggshell for up to 21 days. During the 21 day incubation timeframe, the bacteria will move from the outside of the egg to the interior portion of the egg. As the albumin is the source of some probiotic bacteria, it is preferred that at least one bacterial species can transfer from the eggshell surface to the albumin portion of the egg during incubation. In a preferred embodiment at least one bacterial species is also capable of moving into the yolk portion of the egg. In one embodiment the prebiotics are included in the composition in a total weight range from 0.01% to 10% w/w of the final composition, but are optimally included from 0.1 to 1% w/w of the final composition.

It is yet another objective of the subject matter of the present disclosure to provide a probiotic egg wash that is applied to the exterior surface of an eggshell, wherein the mixture is supplied as a concentrated powder and diluted on site to the indicated CFU per egg.

It is a further objective of the present disclosure to provide a probiotic egg wash that is applied to the exterior surface of an eggshell, wherein the mixture is supplied as a pre-diluted solution with active bacteria.

It is still a further objective of the subject matter of the present disclosure to provide a probiotic egg wash that is applied to the exterior surface of an eggshell, wherein the solution is spray, dip, or wipe applied to the egg.

It is yet a further objective of the present disclosure to provide a probiotic egg wash that is applied to the exterior surface of an eggshell, wherein the powder is directly applied to the egg without dilution via spray, dip, or wipe.

Various other objectives and advantages of the subject matter of the present disclosure will become apparent to those skilled in the art as a more detailed description is set forth below.

### SUMMARY OF THE INVENTION

The aforesaid and other objectives are realized by providing a probiotic egg wash for the exterior surface of the eggshell that is ingested by the developing embryo resulting in an established GI tract microbiome that promotes health and outcompetes potential pathogens such as Salmonella. The probiotic eggwash includes a probiotic mixture. In the preferred embodiment, the probiotic mixture of the eggwash is composed at least of one or more of L. casei, L. rhamnosus, L. planitarum, L. paracasei, and/or B. lactis at a concentration of between 10⁵ to 10¹² Colony Forming Units (CFU) per egg. The probiotic mixture includes a species of shell probiotic that is capable of surviving on the exterior surface of an eggshell. Once the probiotic eggwash is applied on the egg at the required concentration the species of shell probiotic in the eggwash will survive on the eggshell for 3 to 30 days, but in a preferred embodiment, the eggwash includes at least two species of shell probiotic that can survive on the eggshell for up to 21 days. During the 21 day incubation timeframe, the bacteria will move from the outside of the egg to the interior portion of the egg. As the albumin (the “egg white”) is the source of some probiotic bacteria, so it is preferred that the eggwash includes a species of traversing probiotic that is capable of traversing the eggshell and impregnating the albumin (“egg white”) and/or egg yolk during incubation. The probiotic mixture further includes a species of gastric-juice resistant probiotic that is capable of forming a biofilm in a GI environment of a developing embryo. The probiotic egg wash also may include a prebiotic, a pH modifier, and an enzymatic co factor to increase the viability of the probiotics.

### BRIEF DESCRIPTION OF THE DRAWINGS

FIG. 1 shows a schematic representation of a probiotic eggwash being deposited onto an exterior surface of an eggshell as described herein.

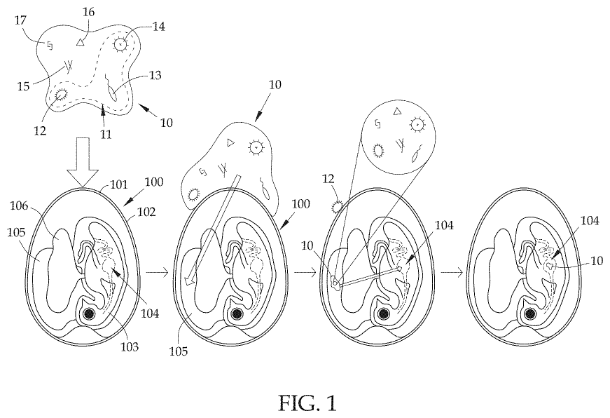

FIG. 2 shows an inhibitory effect of potential probiotic strains against E. coli, S. typhimirium, and L. monoctyogenes in Table 1 showing MIC in MRS.

FIG. 3 shows strains subjected to Acid and Bile in Table 2 showing survival rate.

FIG. 4A demonstrates media only reading subtracted from media+bacteria readings to determine the OD₅₄₀ calculation.

FIG. 4B illustrates representative plates demonstrating the enhanced biofilm formation, as noted by the presence of ACV remaining on the well after washes.

FIG. 5 demonstrates a graph of planktonic outcompetition.

FIG. 6 demonstrates a graph of biofilm exclusion.

FIG. 7 demonstrates a graph of biofilm displacement.

FIG. 8 demonstrates a graph of survival on egg shell.

FIG. 9 demonstrates a graph of migration into the albumin.

FIG. 10 demonstrates a graph of migration into the yolk.

### DETAILED DESCRIPTION OF THE PREFERRED EMBODIMENT AND OPERATION OF THE INVENTION

Various exemplary embodiments of the present disclosure are described below. Use of the term “exemplary” means illustrative or by way of example only, and any reference herein to “the invention” is not intended to restrict or limit the scope of the disclosure to exact features or step of any one or more of the exemplary embodiments disclosed in the present specification. References to “exemplary embodiment”, “one embodiment”, “an embodiment”, “various embodiments”, and the like may indicate that the embodiment(s) of the disclosure so described may include a particular feature, structure, or characteristic, but not every embodiment necessarily incudes the particular feature, structure, or characteristic. Further, repeated use of the phrase “in one embodiment”, “in an exemplary embodiment”, or “in an alternative embodiment” do not necessarily refer to the same embodiment, although they may.

It is also noted that terms like “preferably”, “commonly”, and “typically” are not utilized herein to limit the scope of the disclosure or to imply that certain features are critical, essential, or even important to the structure or function of the disclosure. Rather, these terms are merely intended to highlight alternative or additional features that may or may not be utilized in a particular embodiment of the subject matter of the present disclosure.

The present disclosure is described more fully hereinafter with reference to the accompanying figures, in which one or more exemplary embodiments of the disclosure are shown. Like numbers used herein refer to like elements throughout. The subject matter of the present disclosure may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limited as to the scope of the disclosure, and any and all equivalents thereof. Moreover, many embodiments such as adaptations, variations, modifications, and equivalent arrangements will be implicitly disclosed by the embodiments described herein and fall within the scope of the instant disclosure.

Although specific terms are employed herein, they are used in a generic and descriptive sense only and not for the purposes of limitation. Unless otherwise expressly defined herein, such terms are intended to be given their broad, ordinary, and customary meaning not inconsistent with that applicable in the relevant industry ad without restriction to any specific embodiment hereinafter described. As used herein, the article “a” is intended to include one or more items. Where only one item is intended, the terms “one and only one”, “single”, or similar language is used. When used herein to join a list of items, the term “or” denotes at least one of the items, but does not exclude a plurality of items of the list.

For exemplary methods or processes of the subject matter of the present disclosure, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present disclosure.

Additionally, any references to advantages, benefits, unexpected results, or operability of the present disclosure are not intended as an affirmation that the subject matter has previously been reduced to practice or that any testing has been performed. Likewise, unless stated otherwise, use of verbs in the past tense (present perfect or preterit) is not intended to indicate or imply that the subject matter of the present disclosure has previously been reduced to practice or that any testing has been performed.

As used herein, “probiotics” are bacteria that are known to be capable of adhering to intestinal cells and of excluding pathogenic bacteria on intestinal cells. To have this activity, the probiotic bacteria must remain viable in the product until it is consumed.

As used herein, “prebiotic” means food substances that promote the growth of probiotics in the GI tract. They are not usually broken down in the stomach and/or upper intestine or absorbed in the GI tract of the animal ingesting them, but they are fermented by the gastrointestinal microflora and/or by probiotics. The prebiotics that may be used in accordance with the present disclosure are not particularly limited and include all food substances known by those skilled in the art that promote the growth of probiotics in the intestines.

For a better understanding of the subject matter of the present disclosure and its operation, a probiotic egg wash 10 is disclosed that is configured to be placed on an exterior surface 102 of an eggshell 101 of a developing chick 103 to traverse the eggshell 101 to enter the egg white (also referred to herein as “albumin”) 105. Once in the egg white 105, the bacteria will be ingested by the developing embryo 103 and create a cascade event resulting in a hatching chick that will have an established GI tract microbiome which promotes health and outcompetes pathogens. In one or more embodiments, egg wash 10 includes a probiotic mixture 11, said probiotic mixture 11 including one or more probiotics selected from the group consisting of: Aspergillus niger, Aspergillus oryzae, Bacillus amyloliquefaciens, Bacillus coagulens, Bacillus lentus, Bacillus pumilus, Bacteroides amylophilus, Bacteroides capillosus, Bacteroides ruminocola, Bacteroides suis, Bifidobacterium adolescentis, Bifidobacterium animalis, Bifidobacterium infantis, enterococcus cremorus, Enterococcus diacetylactis, Enterococcus faecium, Enterococcus intermedius, Enterococcus lactis, Enterococcus thermophilus, Lactobacillus animalis, Lactobacillus brevis, Lactobacillus bulgaricus, Lactobacillus cellobiosus, Lactobacillus curvatus, Lactobacillus delbruecki, Lactbacillus fermentum, Lactobacillus helveticus, Lactobacillus reuteri, Leuconostic mesenteroides, Pediococcus acidilactici, Pediococcus damnosus, Pediococcus pentosaceus, Propiniobacterium freudenreichii, Propiniobacterium shermanii, Rhodopseudomonas palustris, Saccharomyces cerevisiae, Lactobcillus casei, Lactobacillus rhamnosus, Lactobacillus plantarum, Lactobacillus paracasei, Lactobacillus acidophilus, Lactobacillus lactis, Bacillus subtilis, Bacillus lichenformis, Bifidobacterium bifidum, Bifidobacterium lactis, Bifidobacterium longum, and Bifidobacterium thermophilum, and mixtures thereof. A preferable probiotic mixture 11 contains at least L. casei, L. rhamnosus, L. planitarum, L. paracasei, or B. lactis. The probiotic components of egg wash 10 in the final wash exist in a range of CFU per egg from 10⁵ to 10¹⁵. The preferred concentration is 10⁶ to 10¹² CFU (“colony forming unit”) per egg. The optimal application rate is 10⁷ to 10¹⁰ CFU per egg. In one or more alternative embodiments, the concentration is 10² to 10⁹ CFU per egg.

Various application methods utilizing egg wash 10 being applied to the exterior surface 102 of an eggshell 101 are considered within the scope of the present disclosure. One acceptable application technique contemplates egg wash 10 provided as a concentrated powder and diluted on site to the indicated CFU per egg. An alternate application technique wherein egg wash 10 is supplied as a pre-diluted solution with active bacteria. Embodiments of probiotic egg wash 10 may be applied to the exterior surface 102 of an eggshell 101, wherein the solution is spray, dip, or wipe applied to the egg 100; or wherein the powder is directly applied to the egg 100 without dilution via spray, dip, or wipe.

The probiotic composition 11 of eggwash 10 includes a species of shell probiotic 12. Once egg wash 10 is applied on the egg 100 at the required concentration, the species of shell probiotic 12, selected from a group consisting of at least one of the aforementioned bacterial species, described above will survive on the exterior surface 102 of the eggshell 101 for 3 to 30 days. In some embodiments, the species of shell probiotic 12 of egg wash 10 can survive for up to 21 days on/in the egg 100. In a preferred embodiment, the probiotic mixture 11 includes two species of shell probiotic 12 that can survive on the eggshell 101 for up to 21 days.

In a preferred embodiment, the probiotic composition 11 of eggwash 10 includes a species of traversing probiotic 13 capable of traversing the eggshell 101 and impregnating the egg white 105 and/or egg yolk 106.

As the GI tract 104 has a unique environment it is expected that the probiotic mixture 11 of egg wash 10 must also withstand the GI environment. Simulated gastric juices are utilized to mimic the GI environment in vitro. Therefore, the probiotic mixture 11 of eggwash 10 includes a species of gastric-juice resistant probiotic 14 that demonstrates viability in simulated gastric juices. It is preferred that the species of gastric juice resistant probiotic 14 of egg wash 10 is capable of forming a biofilm in the simulated gastric juices. The species of gastric-juice resistant probiotic 104 is also capable of forming a biofilm in the GI tract 104 of the developing embryo 103.

The poultry industry faces numerous pathogens of concern. One use of the disclosed composition is the reduction of carriage and symptoms caused by multiple organisms including but not limited to Salmonella, Campylobacter, Eimeria, Clostridium, Escherichia coli and alternate Enterobacteriaceae. As probiotics are known to help with health and well-being, one use of the disclosed eggwash 10 is to improve overall flock health. Improvement of overall flock health can be measured by increased weight conversion and a decrease in mortality rates throughout the lifecycle. The ability of Lactobacillus and other probiotic species to colonize a GI tract is also dependent on the presence of key nutrients. Specifically, prebiotics that are utilized as a carbon source for the bacterial strains. These prebiotics maybe broken down into short chain fatty acids to provide a mechanistic basis for outcompetition. In one or more embodiments, the eggwash 10 further comprises a prebiotic 15, selected from a group consisting of: plant-based oils (including soybean oil, sunflower oil, coconut oil and all vegetable oils), xylo-oligosaccharides, fructo-oligosaccharides, galacto-oligosaccharides, xylan, pullulan, gentibiose, polydextrose, and lactitol, and combinations thereof. In a preferred embodiment of the eggwash 10, the prebiotic 15 is selected from a group consisting of xylo-oliogsaccharide and fructo-oligosaccharide, and combinations thereof. The prebiotic will increase the viability of the bacterial strains upon entry into the GI track 104 of the chick 103. In one or more embodiments of egg wash 10, the prebiotic 15 is included in the eggwash 10 in a total weight range from 0.001% to 10% w/w of the final composition. Optimally the prebiotic 15 is included from 0.01 to 1% w/w of the final composition of egg wash 10. The prebiotic 15 can be provided in the isolated form, such as pure fructo oligosaccharide, or as a precursor material that is high in prebiotic content, such as but not limited to sugarcane or naturally occurring xylan with xylo-oligosaccharide, or chicory root and inulin for fructo-oligosaccharides.

In order to provide optimal growth within the GI tract 104, the eggwash 10 may include a pH modifier 16 in the range from 0.001 to 1.0% w/w. Optimally, the pH modifier 16 may be included at a range from 0.005% to 0.5% w/w. In some embodiments, the pH modifier 16 is selected from a group consisting of: citrate (and salts thereof), acetate (and salts thereof), fumaric acid (and salts thereof), glutamic acid (and salts thereof), phosphoric acid (and salts thereof), magnesium sulfate, and manganese sulfate, and combinations thereof.

Additionally, many bacteria require enzyme co-factors to thrive in a given environment. These co-factors can provide a competitive edge to the probiotic strains listed in this disclosure. As such, the eggwash 10 may include an enzymatic co-factor 17 in the range from 0.001 to 1.0% w/w. Optimally, the enzymatic co-factor 17) can be included at a range from 0.005% to 0.5%. In some embodiments, the enzymatic co-factor 17 are fat soluble vitamins (such as A, D, E, and K), water soluble vitamins (such as B1, B¬2, B3, B6, B12, biotin, folic acid, pantothenic acid, and C) and divalent cations (such as magnesium, manganese, calcium, beryllium, barium, strontium, cobalt, copper, nickel, iron, and cadmium or salts thereof), and combinations thereof.

This disclosure contemplates embodiments of the probiotic eggwash 10 where one species of probiotic may fulfill the role of shell probiotic 12, traversing probiotic 13, and gastric-juice probiotic 14, and permutations thereof. In some embodiments, one unique species of probiotic may be used as the shell probiotic 12, traversing probiotic 13, and the gastric-juice resistant probiotic 14, so that the probiotic mixture 11 is composed of only one unique species of probiotic.

In some instances, the microbiome of the hatched chick will be disrupted and it will need to be restored. In this instance, the described composition or portions can be utilized as a feed additive. In this case, the end concentration will be those already described above.

### EXAMPLES

### Example 1: Antagonistic Activity Against Pathogenic Bacteria is Species Specific

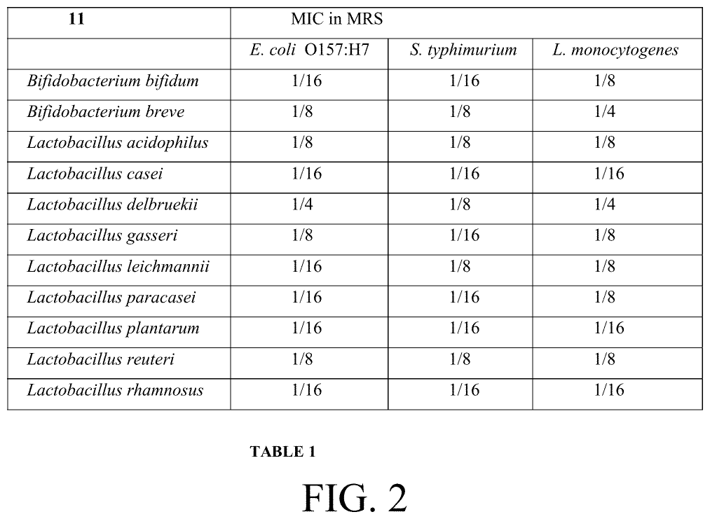

There is an inhibitory effect of potential probiotic strains against E. coli, S. typhimirium, and L. monoctyogenes. Briefly, bacteria were grown in MRS broth and the supernatant isolated. The MIC of the supernatant was evaluated against the 3 listed pathogens. The lower the number the higher the antagonistic effect of the probiotic supernatant. As noted in the data, some strains and species have improved antagonistic activity when compared to others as seen in Table 1 of FIG. 2.

### Example 2: Acid and Bile Tolerance is Species Specific

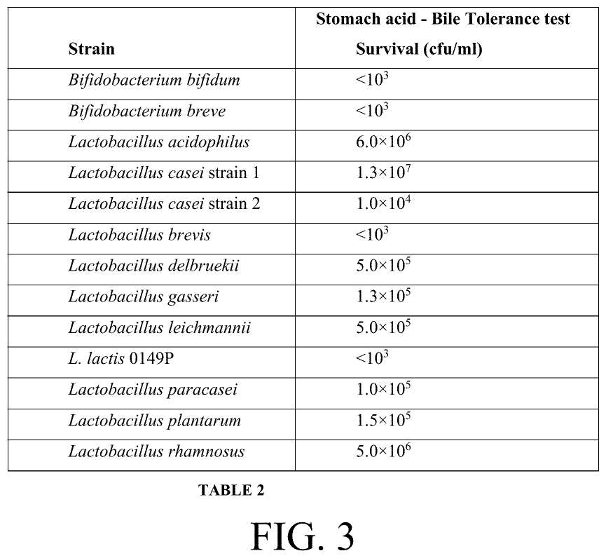

These strains were subjected to exposure to bile and stomach acids. Following exposure, the resulting colonies were counted. Those exhibiting higher CFU counts demonstrate an increased resistance to stomach acid and bile salts. As demonstrated in Table 2 of FIG. 3, bile and acid sensitivity is uniquely strain specific.

### Example 3: Ability to Form Biofilms is Species Specific

Strains were selected based on antagonistic activity and bile tolerance for further study. Strains were added to a 96 well microtiter dish containing TSB+0.1% bile salts to mimic the gastric environment. The 96 well dishes were placed at 37° C. and biofilm formation measured over the course of 3 days with crystal violet.

Strains of Lactobacillus rhamnosus, Lactobacillus paracasei, and Bifidobacter lactis were selected for biofilm studies. Each strain was resuspended from a lyophilized starter to obtain 10¹⁰ colony forming units (CFU)/mL. This was then diluted to obtain 10⁵ CFU/mL in one of 4 media types:

1. MRS broth

2. MRS broth+10% heat treated egg yolk

3. MRS broth+1% gastric juice

4. MRS broth+1 mg/ml of prebiotic (XOS or lactitol)

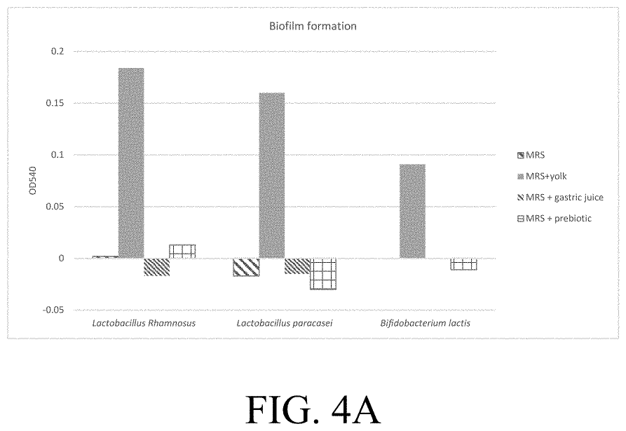

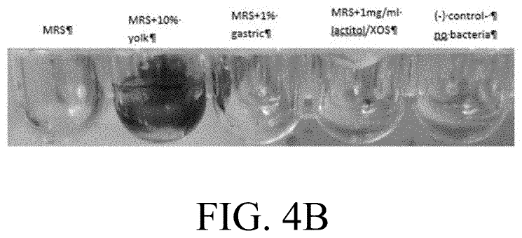

100 ul of each media and bacterial species was then added to 6 wells of a 96 well dish. The plates were sealed and incubated at 37° C. for 18-24 hours under anaerobic conditions (Thermo Scientific AnaeroGen 3.5 L). Following incubation, the plates were removed and the planktonic cultures were discarded. Plates were vigorously washed in water to remove non-adherent cells. 100 ul of advanced crystal violet (ACV) was added to wells for 30 minutes under ambient conditions. The plates were washed to remove unbound ACV. The remaining ACV was solubilized with 95% isopropyl alcohol, pooled from 6 samples, and the optical density at 540 nm determined. For each media type of blank media only control was utilized to determine any background staining resulting from any media type. Media only readings were subtracted from media+bacteria readings to determine the OD₅₄₀ as shown in FIG. 4A. FIG. 4B is a picture of a representative plates demonstrated the enhanced biofilm formation, as noted by the presence of ACV remaining on the well after washes. FIGS. 4A and 4B: The egg yolk provides optimal conditions for biofilm formation

For all 3 strains represented the inclusion of 10% yolk provided noticeable biofilm formation over that of the control. This was not observed for MRS alone or MRS supplemented with either gastric juice or prebiotic. As such it can be concluded that the egg yolk provides optimal conditions for biofilm formation by the selected probiotic strains.

### Example 4: Planktonic Out Competition of Salmonella

Typical outcompetition focuses on planktonic, free swimming, cells of two different species competing for the same nutrients. To compare the ability of the selected probiotic strains to outcompete Salmonella, each strain was allowed to form a biofilm first. Briefly, the probiotic strains were added separately or as a mixture in MRS broth supplemented with 10% heat treated egg yolk into 96 well dishes and incubated anaerobically at 37° C. for 18-24 hours. Once a biofilm was formed, the media was removed and replaced with MRS broth+10% yolk that had been inoculated with Salmonella enterica serovar newport. This was incubated anaerobically at 37° C. for 18-24 hours. The resulting planktonic media was recovered and enumerated on Brilliant Green agar to select for Salmonella.

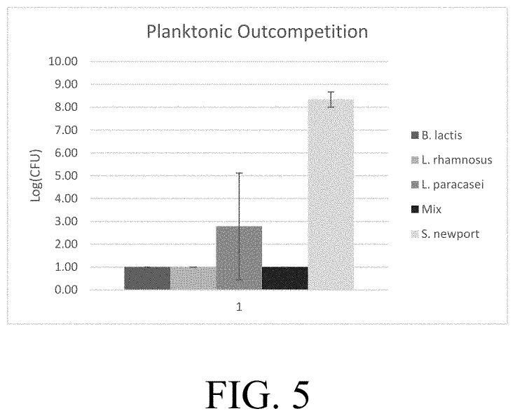

B. lactis and L. rhamnosus were able to reduce Salmonella in the planktonic state below the limit of detection, a comparative >7 log reduction. L. paracasei had increased variability with the reduction but still performed at a >5 log reduction level as shown in FIG. 5. This indicates an ability to out compete for all selected strains in the planktonic state.

### Example 5: Biofilm Out Competition of Salmonella

Biofilm exclusion is the process by which one bacterial species is already established on a surface and a second species then enters the environment. The biofilm of the first species prevents the second species from adhering to the surface, thereby excluding the second species. In order to investigate biofilm exclusion, each strain was allowed to form a biofilm first. Briefly, the probiotic strains were added separately or as a mixture in MRS broth supplemented with 10% heat treated egg yolk into 96 well dishes and incubated anaerobically at 37° C. for 18-24 hours. Once a biofilm was formed, the media was removed and replaced with MRS broth +10% yolk that had been inoculated with Salmonella enterica serovar newport. This was incubated anaerobically at 37° C. for 18-24 hours. The media was removed and replaced with 1004, of PBS. The biofilm in the well was scraped into the PBS and enumerated on Brillant Green Agar to distinguish Salmonella.

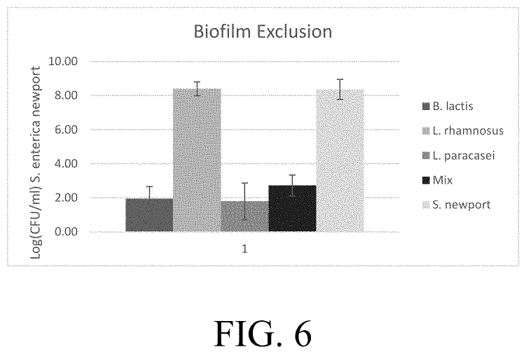

As demonstrated in FIG. 6, B. lactis and L. paracasei provides a complete reduction below the lower limit of detection for Salmonella, a >6 log reduction. Interestingly, while L. rhamnosus was able to effectively outcompete Salmonella it was not able to exclude. This indicates that a mixture of probiotic strains is optimal for efficient out competition of target pathogens.

Biofilm displacement is when one species has established a biofilm on a surface and a second species is introduced into the system. The second species is able to replace the first species on the surface, thereby displacing it from the environment. For this experiment, Salmonella was the first species introduced. 96 well plates were seeded with Salmonella in MRS broth supplemented with 10% heat treated egg yolk and incubated at 37° C. for 18-24 hours. The media was then removed and replaced with supplemented with 10% heat treated egg yolk alone or with a mixture of B. lactis, L. rhamnosus, and L. paracasei. This was incubated anaerobically at 37° C. for 18-24 hours. The media was removed and replaced with 1004, of PBS. The biofilm in the well was scraped into the PBS and enumerated on Brillant Green Agar to distinguish Salmonella.

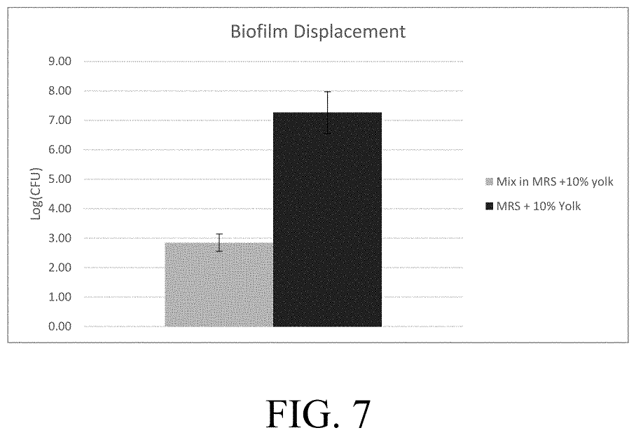

After 24 hours of incubation, there was a >4 log reduction in adhered Salmonella, indicating that the selected strains are also capable of displacing Salmonella that has already colonized the surface as seen in FIG. 7.

### Example 6: Ability to Survive on Eggshells is Species Specific

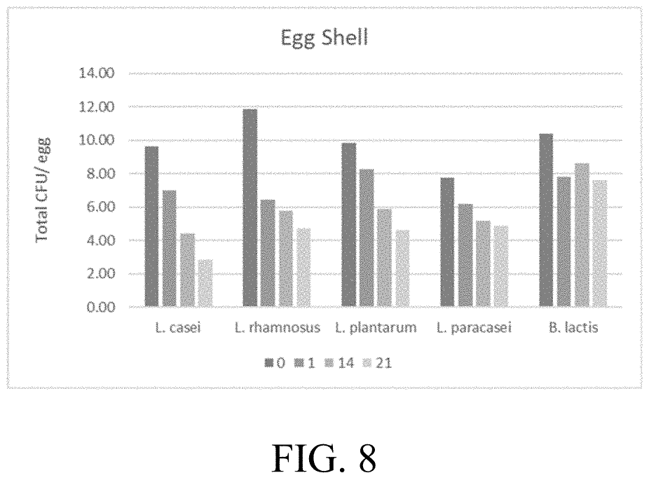

Since poultry eggs incubate for 21 days, the ability of 5 strains of probiotics to survive on the eggshell surface for 21 days was assessed. Large Grade A table eggs were purchased and sanitized with 70% isopropyl alcohol and allowed to air dry. Individual lyophilized bacterial species were resuspended to obtain a concentration of 10⁸ to 10¹² CFU/ml, to create the inoculum. 500 ul of inoculums was spread onto the eggshell. Eggs were incubated at 38° C. for 21 days. At each time point, a swab was placed into 5 mL MRSB and utilized to swab the surface of the egg. The swab was placed back into the tube, vortexed and enumerated at the indicated time point (FIG. 8. n≥3, dashed line indicates lower limit of detection).

### Example 7: Migration into the Albumin and Yolk

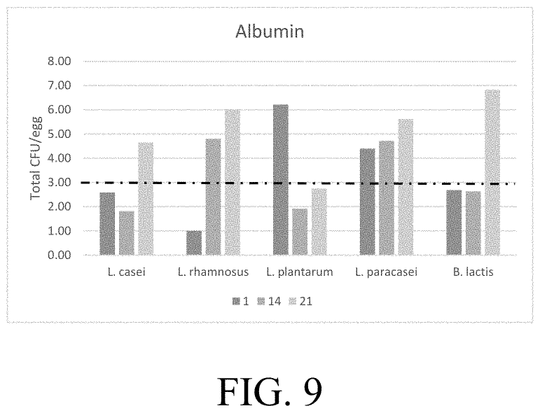

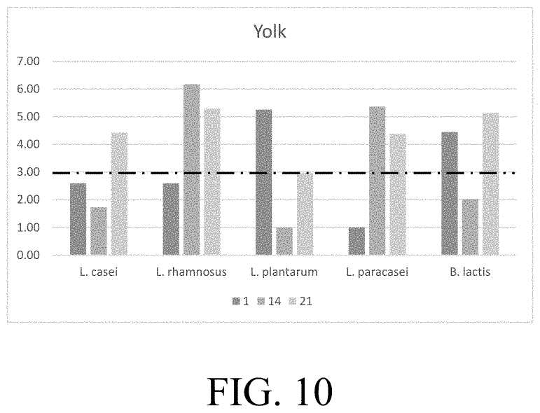

The ability of 5 probiotic strains to migrate from the eggshell into the albumin and yolk were characterized over the 21 day egg incubation period. Large Grade A table eggs were purchased and sanitized with 70% isopropyl alcohol and allowed to air dry. Individual lyophilized bacterial species were resuspended to obtain a concentration of 10⁸ to 10¹² CFU/ml, to create the inoculum. 500 ul of inoculums was spread onto the eggshell. Eggs were incubated at 38° C. for 21 days. At the indicated timepoint the shell above the airsac was cleaned with 70% isopropyl alcohol and a hole was aseptically created above the airsac. A portion of the albumin was removed into a sterile tube followed by a portion of the yolk removed into a sterile tube. Bacterial concentration was enumerated on MRS agar plates (FIGS. 9 and 10, n≥3 and dotted line indicates lower limit of detection). Only 4 of the tested strains were able to demonstrate an ability to migrate into the albumin and yolk.

These experiments demonstrate that the selection of bacterial species is crucial for developing an egg wash with the end benefit of hatching a chick with a GI tract colonized with beneficial bacteria.

The illustrations and examples provided herein are for explanatory purposes and are not intended to limit the scope of the appended claims.

I claim:

1. A probiotic eggwash comprising:
a probiotic mixture (11) comprising:
a species of shell probiotic (12) that is capable of surviving on an exterior surface (102) of an eggshell (101) for up to three days,
a species of traversing probiotic (13) that is capable of traversing the eggshell (102) and impregnating an egg white (105) and/or egg yolk (106) of an egg (100);
wherein the probiotic eggwash (10) is configured to be depositable onto the exterior surface (102) of the eggshell (101);
wherein, the probiotic eggwash (10) is ingestible by a developing embryo (103) within the eggshell (101) so that a GI tract microbiome is established that outcompetes pathogens.

2. The probiotic eggwash of claim 1, wherein said probiotic mixture (11) further comprising a species of gastric-juice resistant probiotic (14) capable of surviving in and forming a biofilm in a GI environment.

3. The probiotic eggwash of claim 2, wherein the species of gastric-juice resistant probiotic (14) is capable of forming a biofilm in a GI tract (104) of the developing embryo (103).

4. The probiotic eggwash of claim 2, wherein the species of shell probiotic (12) is capable of surviving up to 21 days on the exterior surface (102) of the eggshell (101).

5. The probiotic eggwash of claim 2, wherein the probiotic mixture (11) includes at least two different species of shell probiotic (12), each capable of surviving up to 21 days on the exterior surface (102) of the eggshell (101).

6. The probiotic eggwash of claim 1, wherein said probiotic mixture (11) is selected from a group consisting of: Lactobacillus, Bifidobacterium, and Bacillus, and combinations thereof.

7. The probiotic eggwash of claim 1 further comprising a prebiotic (15) for increasing viability of probiotics.

8. The probiotic eggwash of claim 7, wherein said prebiotic (15) is selected from a group consisting of: plant-based oils, xylo-oligosaccharides, fructo-oligosaccharides, galacto-oligosaccharides, xylan, pullulan, gentibiose, polydextrose, and lactitol and combinations thereof.

9. The probiotic eggwash of claim 7, wherein said prebiotic (15) is selected from a group consisting of: xylo-oliogsaccharide and fructo-oligosaccharide, and combinations thereof.

10. The probiotic eggwash of claim 7, wherein said prebiotic (15) is a precursor material.

11. The probiotic eggwash of claim 1 further comprising a pH modifier (16) selected from a group consisting of: citrate and salts thereof, acetate and salts thereof, fumaric acid and salts thereof, glutamic acid and salts thereof, phosphoric acid and salts thereof, magnesium sulfate, and manganese sulfate, and mixtures thereof.

12. The probiotic eggwash of claim 1 further comprising a co-factor (17) for increasing the viability of probiotics.

13. The probiotic eggwash of claim 12, wherein a co-factor (17) is selected from a group consisting of: fat soluble vitamins, water soluble vitamins, and divalent cations, and mixtures thereof.

14. The probiotic eggwash of claim 1, wherein the probiotic eggwash (11) is depositable onto the exterior surface (102) of the eggshell (101) at a concentration of 10⁵ to 10¹⁵ CFU per egg.

15. The probiotic eggwash of claim 1, wherein the probiotic eggwash (11) is depositable onto the exterior surface (102) of the eggshell (101) at a concentration of 10² to 10⁹ CFU per egg.

16. The probiotic eggwash of claim 1 further comprising:
a co-factor (17), said co-factor (17) is selected from a group consisting of: fat soluble vitamins, water soluble vitamins, and divalent cations, and mixtures thereof;
a pH modifier (16), said pH modifier (16) is selected from a group consisting of: citrate and salts thereof, acetate and salts thereof, fumaric acid and salts thereof, glutamic acid and salts thereof, phosphoric acid and salts thereof, magnesium sulfate, and manganese sulfate, and mixtures thereof;
a prebiotic (15), said prebiotic is selected from a group consisting of: plant-based oils, xylo-oligosaccharides, fructo-oligosaccharides, galacto-oligosaccharides, xylan, pullulan, gentibiose, polydextrose, and lactitol and mixtures thereof.

17. The probiotic eggwash of claim 16, wherein said probiotic mixture (11) including at least two different species of shell probiotic (12) each capable of surviving up to 21 days on the exterior surface (102) of the eggshell (101).

18. The probiotic eggwash of claim 17, wherein said probiotic mixture (11) further comprising a species of gastric-juice resistant probiotic (14) capable of forming a biofilm in a GI environment of the developing embryo (103).

19. The probiotic eggwash of claim 18, wherein the probiotic eggwash (10) is depositable on the exterior surface (102) of the eggshell (101) at a concentration of 10⁵ to 10¹⁵ CFU per egg.

20. The probiotic eggwash of claim 18, wherein the probiotic eggwash (10) is depositable on the exterior surface (102) of the eggshell (101) at a concentration of 10² to 10⁹ CFU per egg.
